(19) United States
(12) Patent Application Publication
(10) Pub. No.: US 2006/0138748 A1
(43) Pub. Date: Jun. 29, 2006

(54) Head protecting airbag

(75) Inventors: Masao Kino, Aichi-ken (JP); Tadashi Yamada, Aichi-ken (JP); Takanobu Ikeda, Aichi-ken (JP); Tadashi Yamamoto, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/301,248

(22) Filed: Dec. 13, 2005

(30) Foreign Application Priority Data
Dec. 20, 2004 (JP) 2004-367963

(51) Int. Cl. B60R 21/16

(52) U.S. Cl. 280/728.1

(57) ABSTRACT

A head protecting airbag includes a bag body and an inner tube. The inner tube is provided within the bag body so as to be separated with respect to an inner peripheral surface of an inflation main part of the bag body so as provide a protecting area directly therebelow and is supported by a support cloth which is joined to an internal side of the inflation main part around an outer periphery thereof. The support cloth is provided integrally with the inflation main part as a substantially tubular shape which has a shorter longitudinal length than that of the inner tube and which can wrap up the inner tube, when outer peripheral parts of interior and exterior wall portions which are located on an upper edge of the inflation main part above the inner tube are joined to each other.

### BACKGROUND OF THE INVENTION

1. Field of the Invention

The invention relates to a head protecting airbag which is adapted to be inflated and deployed downward from an upper edge of a window (a side window) of a vehicle when an inflating gas is allowed to flow thereinto so as to cover an interior side of the window so as to protect the head of an occupant.

2. Related Art

Head protecting airbags of related art are constructed to be folded up and housed in an upper part of a window of a vehicle on an interior side thereof so as to be inflated and deployed so as to cover the interior side of the window when an inflation gas is allowed to flow thereinto. Furthermore, there are head protecting airbags in which an inner tube is provided within a bag body to prevent the damage of the airbag by virtue of the heat and pressure of the inflation gas or to adjust the direction of the inflation gas (for example, refer to JP-A-2002-321587).

In these airbags, the bag body is constructed to have an inflation main part that is adapted to be inflated so as to cover the window when the inflation gas is allowed to flow thereinto and a tubular connection port part that projects from an upper side of the inflation main part and which is connected to an inflator which supplies inflation gas. In addition, the inner tube is constructed to have a gas outlet port that is inserted from the connection port part into an upper edge of the inflation main part so that the inflation gas from the inflator can be supplied downward from the upper edge of the inflation main part.

In the airbags of related art, however, while the inner tube is supported within the bag body so as to prevent a change in orientation of the gas outlet port due to the deflection of the inner tube at an initial stage of inflation of the airbag to thereby attain a smooth downward inflation and deployment of the inflation main part, the support of the inner tube is attained by making use of a thickness restricting portion that is provided with an interior wall portion and an exterior wall portion of the inflation main part which are joined to each other so as to restrict the thickness of the inflation main part such that the bag body is inflated into a plate-like shape. Namely, a lower edge of the inner tube is constructed to be supported by an upper end of the thickness restricting portion.

Due to this, since the thickness cannot be secured at a location where the thickness restricting portion resides when the inflation main part of the bag body is inflated, no protecting area where the inflation main part is inflated thick cannot be provided over a whole area directly below the inner tube.

### SUMMARY OF THE INVENTION

The invention was made to solve the aforesaid problem and an object thereof is to provide a head protecting airbag which can suppress the deflection of the inner tube at the initial stage of inflation of the airbag and can provide a protecting area where the inflation main part is inflated thick over the whole area of the inflation main part which is located directly below the inner tube.

According to a first aspect of the invention, there is provided a head protecting airbag folded and housed in an upper part of a window so as to be inflatable to cover an interior side of the window when an inflation gas flows therein, comprising:

a bag body provided with a joined bag formed by joining outer peripheral parts of an interior wall portion and an exterior wall portion, the bag body having an inflation main part which is inflatable to cover the window when the inflation gas is allowed to flow therein and a tubular connection port part which communicates with an upper side of the inflation main part so as to be connected to an inflator for supplying the inflating gas; and

an inner tube which extends in the connection port part along an upper edge of an inside of the inflation main part and which has a gas outlet port for supplying the inflation gas downward;

wherein the inner tube is housed within the bag body so as not to be joined to an inner peripheral surface of the inflation main part of the bag body except for a location that is in a vicinity of the connection port part, and

an outer periphery of the inner tube except for a location that is in a vicinity of the gas outlet port is supported by a support cloth which is joined integrally to the inflation main part to have a tubular shape such that the support cloth wraps around the inner tube within the inside of the inflation main part,

wherein the support cloth has a shorter longitudinal length than that of the inner tube, and

a part of the support cloth is joined to the outer peripheral parts of the interior and exterior wall portions, when upper edges of the outer peripheral parts of the interior and exterior wall portions located above the inner tube are jointed to each other.

In the head protecting airbag according to the first aspect of the invention, since the support cloth is joined to the upper edge of the inflation main part above the inner tube as the substantially tubular shape which wraps up the inner tube, both the interior wall portion and the exterior wall portion of the inflation main part are not joined with the inner tube and the support cloth over the whole area of the inflation main part which is located near directly below the inner tube but are allowed to be separated from each other to thereby provide a protecting area with a predetermined thickness at the time of inflation. Since the inner tube is wrapped around an outer periphery thereof except for the portion thereof located in the vicinity of the gas outlet port by the support cloth, the deflection of the inner tube is, of course, prevented at the initial stage of the inflation of the airbag.

Consequently, in the head protecting airbag according to the first aspect of the invention, the deflection of the inner tube at the initial stage of the inflation of the airbag can be prevented, and the protecting area that is inflated to the predetermined thickness can be provided over the whole area of the inflation main part which is located directly below the inner tube.

In addition, in the head protecting airbag according to the first aspect of the invention, the inner tube is provided within the bag body so as to be separated with respect to the inner peripheral surface of the inflation main part of the bag body except for the location in the vicinity of the connection port part, and the short support cloth is integrally joined to the upper edge of the bag body instead of joining the long inner tube directly to the upper edge of the joined bag type bag body except for the location in the vicinity of the connection port part, so that the inner tube is constructed to be supported by making use of the support cloth.

Namely, in the event that the long inner tube is interposed between the interior and exterior side wall portions so as to be directly joined to the upper edge of the joined bag type bag body when the interior and exterior wall portions are joined to each other at the upper edge of the bag body, the variation in joining allowance of the interior and exterior wall portions that are joined together makes it difficult to secure a predetermined inside diametrical dimension of the inner tube over the full length thereof. In the airbag according to the first aspect of the invention, however, since the inner tube itself is only interposed between the outer peripheral parts of the interior and exterior wall portions of the bag body and is not joined integrally, the predetermined inside diametrical dimension of the inner tube can be secured over the full length thereof.

In addition, in the event that the long inner tube is interposed between the interior and exterior side wall portions so as to be joined to the upper edge of the joined bag type bag body, when joining together the outer peripheral parts of the interior and exterior wall portions of the bag body using an adhesive, a location where the long inner tube is not interposed is affected by the greater thickness of a location where the inner tube is interposed in such a way that a pressing force cannot smoothly be applied thereto at the time of adhesion, leading to a risk that there is caused a problem in manufacturing the bag body. In the airbag according to the first aspect of the invention, however, since only the short support cloth is interposed between the interior and exterior wall portions, the aforesaid undesirable effect can be suppressed as much as possible.

According to a second aspect of the invention, there is provided a head protecting airbag folded and housed in an upper part of a window so as to be inflatable to cover an interior side of the window when an inflation gas flows therein, including:

a bag body provided with a joined bag formed by joining outer peripheral parts of an interior wall portion and an exterior wall portion, the bag body having an inflation main part which is inflatable to cover the window when the inflation gas is allowed to flow therein and a tubular connection port part which communicates with an upper side of the inflation main part so as to be connected to an inflator for supplying the inflating gas; and

an inner tube which extends in the connection port part along an upper edge of an inside of the inflation main part and which has a gas outlet port for supplying the inflation gas downward;

wherein the inner tube is housed within the bag body so as not to be joined to an inner peripheral surface of the inflation main part of the bag body except for a location that is in a vicinity of the connection port part, and an outer periphery of the inner tube except for a location that is in a vicinity of the gas outlet port is supported by a support cloth which is joined integrally to the inflation main part to have a shape such that the support cloth wraps around the inner tube within the inside of the inflation main part,

wherein the support cloth has a shorter longitudinal length than that of the inner tube, and

an upper edge of the support cloth is joined to upper edges of the outer peripheral parts of the interior and exterior wall portions located above the inner tube, when the outer peripheral parts of the interior and exterior wall portions are jointed to each other and

a lower edge of the support cloth is joined to one of the interior and exterior wall portions at a location below the inner tube.

Also in the head protecting airbag according to the second aspect of the invention, since the support cloth is connected to the portion of the upper edge of the inflation main part which is located above the inner tube and to the portion of either the interior wall portion or the exterior wall portion of the inflation main part which is located near directly below the inner tube, while wrapping up the inner tube except for the location thereof where the outlet port is provided, the interior wall portion and the exterior wall portion of the inflation main part are not joined to each other but are capable of being separated from each other over the whole area of the inflation main part which is located near directly below the inner tube, so that a protecting area having a predetermined thickness can be provided at the time of inflation. Also in this case, since the inner tube is wrapped up by the support cloth and either the interior wall portion or the exterior wall portion to which the lower side of the support cloth is connected, the deflection of the inner tube is, of course, prevented at the initial stage of the inflation of the airbag.

Consequently, the head protecting airbag according to the second aspect of the invention can also suppress the deflation of the inner tube at the initial stage of the inflation of the airbag and can provide the protecting area that is inflated to the predetermined thickness over the whole area of the inflation main part which is located directly below the inner tube.

In addition, also in the airbag according to the second aspect of the invention, since the inner tube itself is not interposed between the outer peripheral parts of the interior and exterior side wall portions of the bag body for integral joining, a predetermined inside diametrical dimension of the inner tube can be secured over the full length of the inner tube. Furthermore, since the support cloth is shorter than the inner tube, when joining together the outer peripheral parts of the interior and exterior wall portions of the bag body by making use of an adhesive, a pressing force required at the time of adhesion can smoothly be applied to the whole area of the bonding location compared with a case where the inner tube is integrally joined to the bag body along the full length thereof.

According to a third aspect of the invention, there is provided a head protecting airbag folded and housed in an upper part of a window so as to be inflatable to cover an interior side of the window when an inflation gas flows therein, including:

a bag body provided with a joined bag formed by joining outer peripheral parts of an interior wall portion and an exterior wall portion, the bag body having an inflation main part which is inflatable to cover the window when the inflation gas is allowed to flow therein and a tubular connection port part which communicates with an upper side of the inflation main part so as to be connected to an inflator for supplying the inflating gas; and

an inner tube which extends in the connection port part along an upper edge of an inside of the inflation main part and which has a gas outlet port for supplying the inflation gas downward;

wherein the inner tube is housed within the bag body so as not to be joined to an inner peripheral surface of the inflation main part of the bag body except for a location that is in a vicinity of the connection port part, and

wherein a separable portion between the interior and exterior wall portions which is formed by separably joining the interior and wall portions to each other are located below the inner tube except for a location that is in a vicinity of the gas outlet port, such that the separable portion of the inflation main part and an upper part of the inflation main part located above the separable portion support the inner tube,

the separable portion is separated at a time when an internal pressure of the inflation main part is increased before a completion of inflation of the inflation main part.

In the head protecting airbag according to the third aspect of the invention, since the separable portion of the inflation main part where the interior and exterior side wall portions thereof are joined together and the upper side thereof that is located above the joined portion support the inner tube at the initial stage of inflation of the airbag, the deflection of the inner tube is suppressed, so that the inflation gas is allowed to flow in a predetermined direction in the inside of the inflation main part. Then, since the joined portion near directly below the inner tube where the interior and exterior wall portions are joined to each other is separated when the internal pressure value is increased as the time is approaching when the inflation main part completes its inflation, the protecting area with a predetermined thickness can be provided over the whole area near directly below the inner tube.

Consequently, also in the head protecting airbag according to the third aspect of the invention, the deflection of the inner tube at the initial stage of inflation of the airbag can be suppressed and the protecting area that is inflated to the predetermined thickness can be provided over the whole area of the inflation main body that is located directly below the inner tube.

In addition, being different from the airbags according to the first and second aspects of the invention, in the airbag according to the third aspect of the invention, since no support cloth is interposed between the outer peripheral parts of the interior and exterior wall portions of the bag body, when applying an adhesive to both the outer peripheral parts of the interior and exterior wall portions of the bag body and pressing the outer peripheral parts to which the adhesive is applied, a uniform pressing force can easily be applied to the entire periphery of the outer edges. Also in this airbag, since the inner tube itself is not interposed between the outer edges of the interior and exterior wall portions of the bag body for integral joining to the bag body, a predetermined inside diametrical dimension of the inner tube can be secured over the full length of the inner tube.

### BRIEF DESCRIPTION OF THE PREFERRED EMBODIMENTS

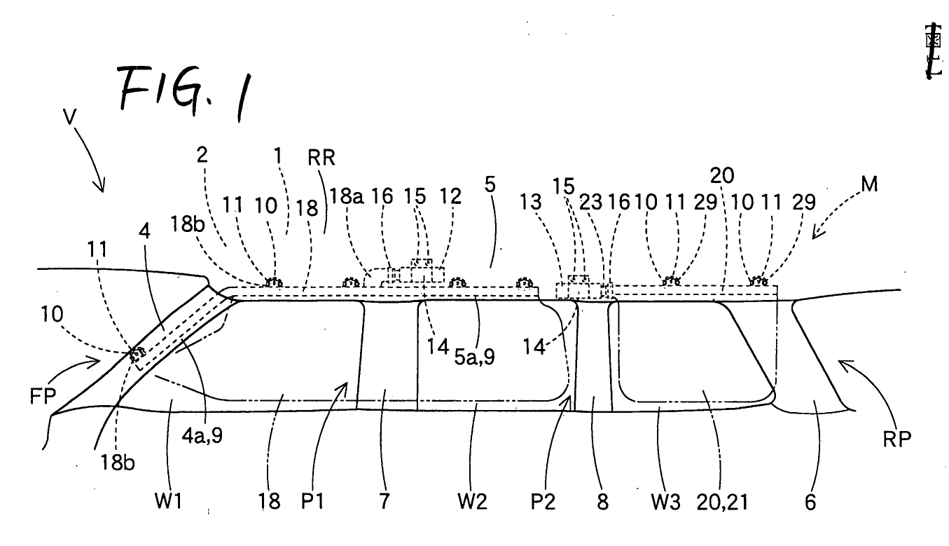

FIG. 1 is a schematic front view showing a state in which a head protecting airbag apparatus is installed in a vehicle in which a head protecting airbag according to a first embodiment of the invention is used;

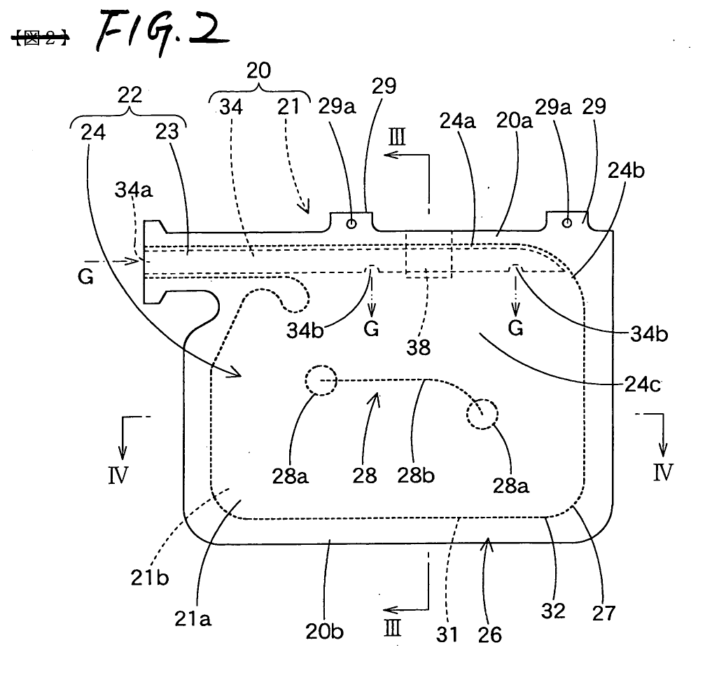

FIG. 2 is a front view of an airbag that is used in the first embodiment;

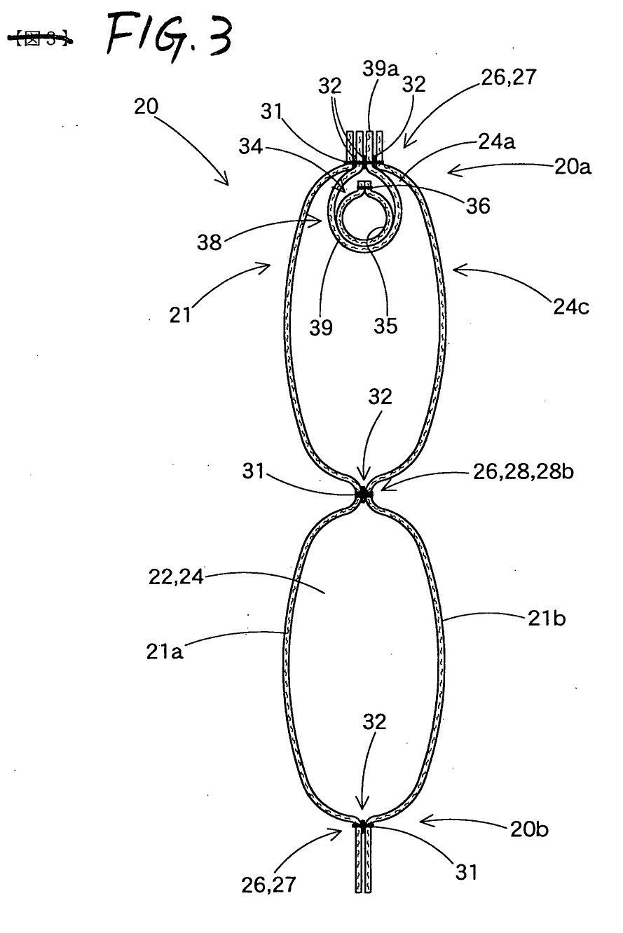

FIG. 3 is a sectional view showing a state in which the airbag used in the first embodiment inflates, which corresponds to a location indicated by the line III-III in FIG. 2;

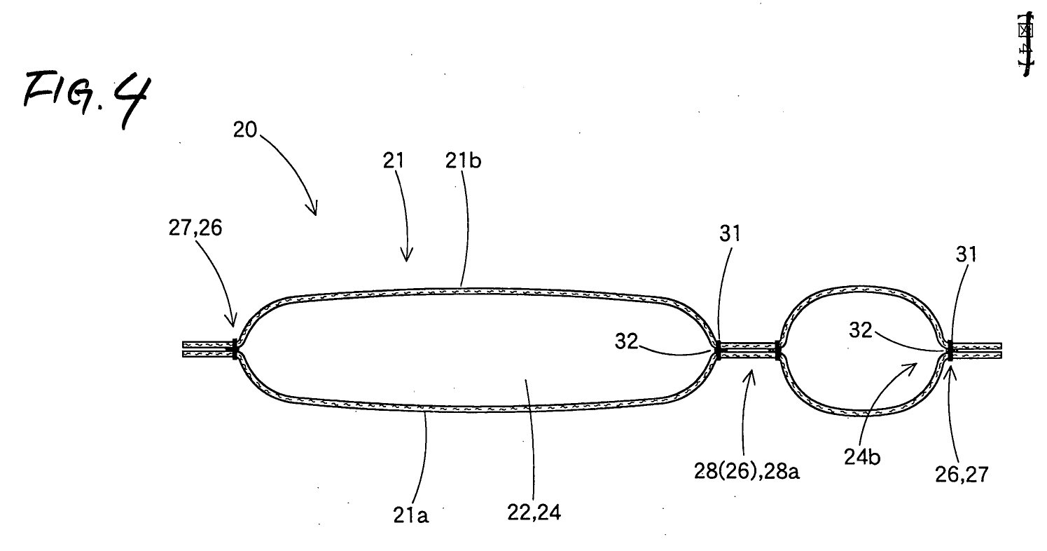

FIG. 4 is a sectional view showing a state in which the airbag used in the first embodiment inflates, which corresponds to a location indicated by the line IV-IV in FIG. 2;

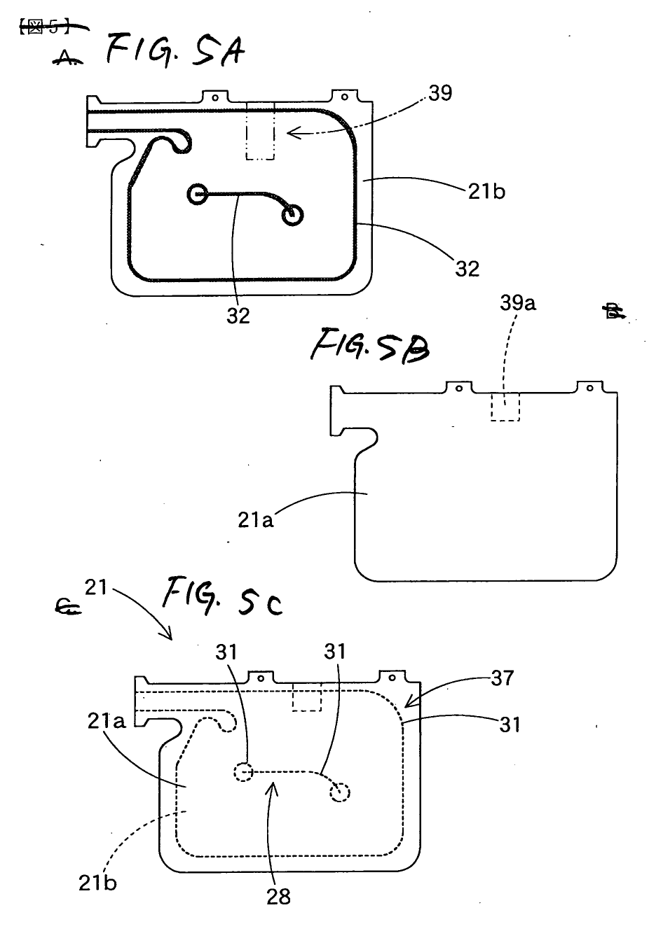

FIGS. 5A through 5C are diagrams which explain a production process of a bag body that is used in the first embodiment.

FIG. 6 is a diagram which explain a production process of an inner tube that is used in the first embodiment.

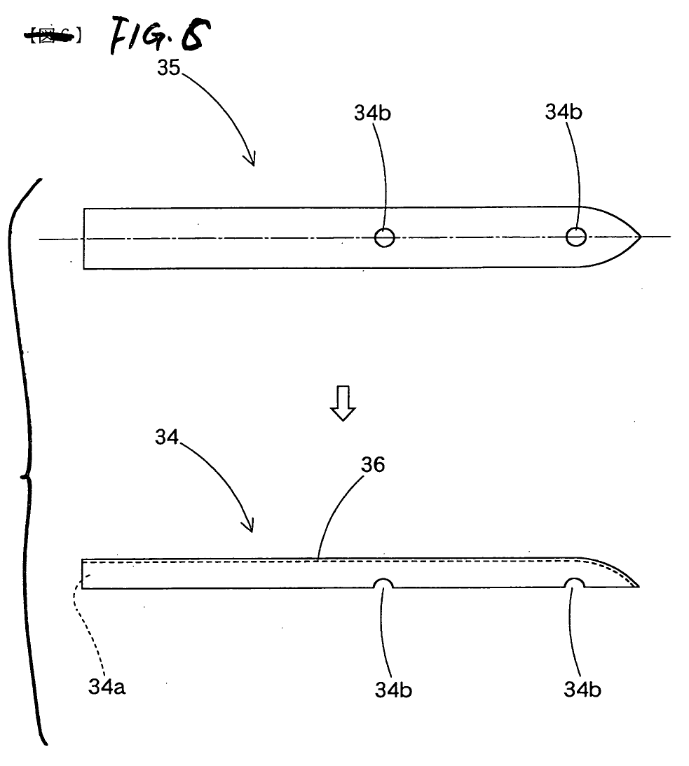

FIGS. 7A through 7C are diagrams which explain a production process of a modified airbag that is used in the first embodiment.

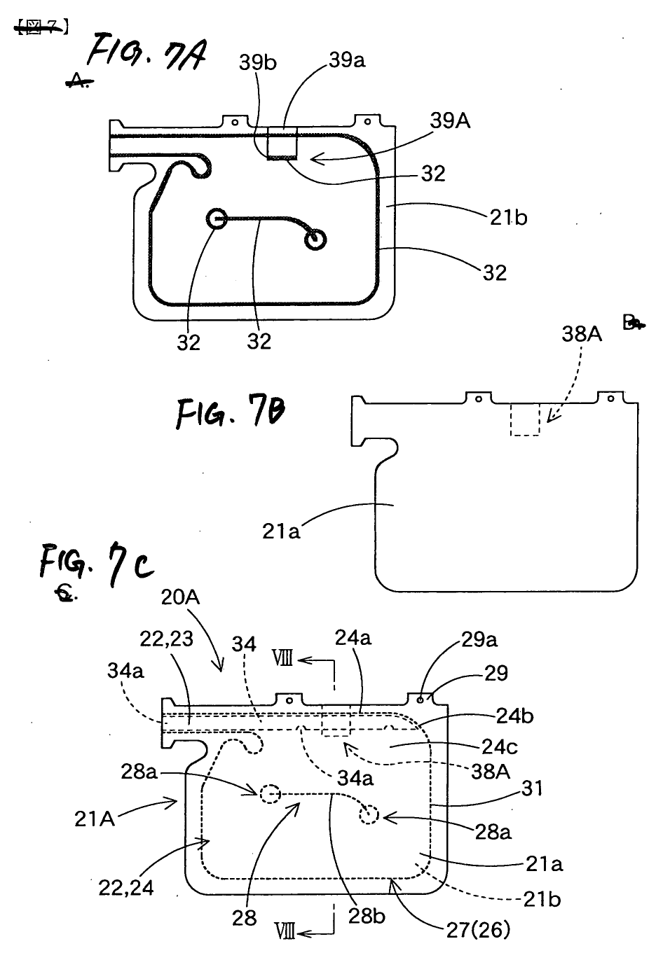

FIG. 8 is a sectional view showing a state in which the airbag shown in FIG. 7C inflates, which corresponds to a location indicated by the line VIII-VIII in FIG. 7C.

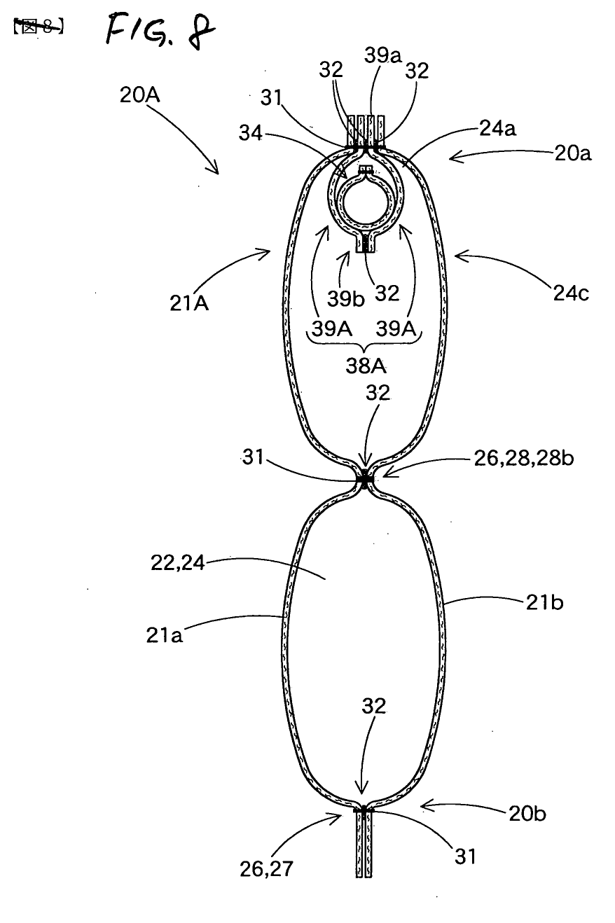

FIG. 9 is a front view which shows an airbag according to a second embodiment.

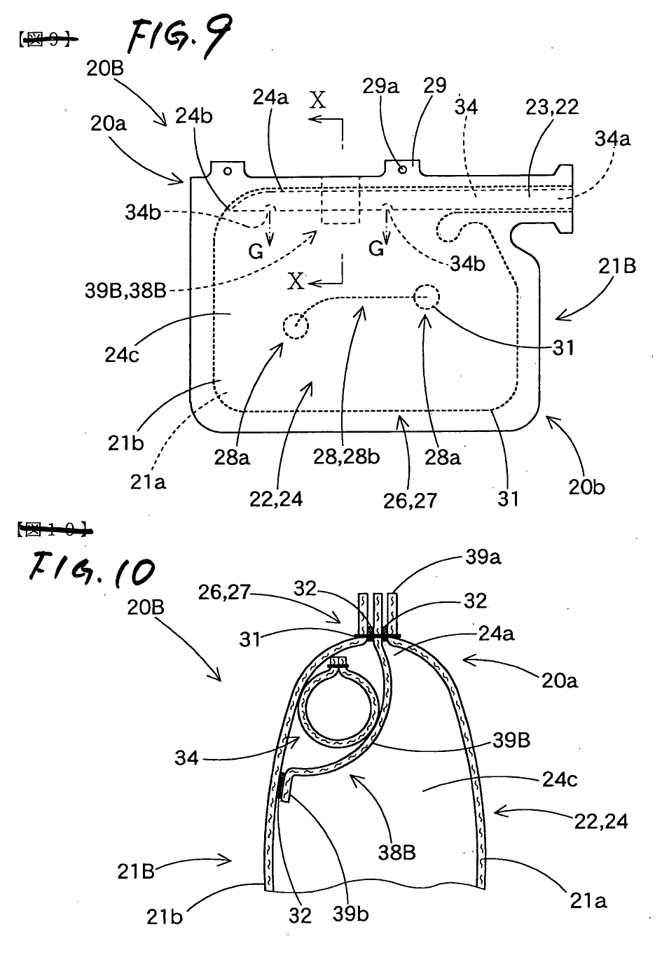

FIG. 10 is a partial sectional view when the airbag according to the second embodiment inflates, which corresponds to a location indicated by the line X-X in FIG. 9.

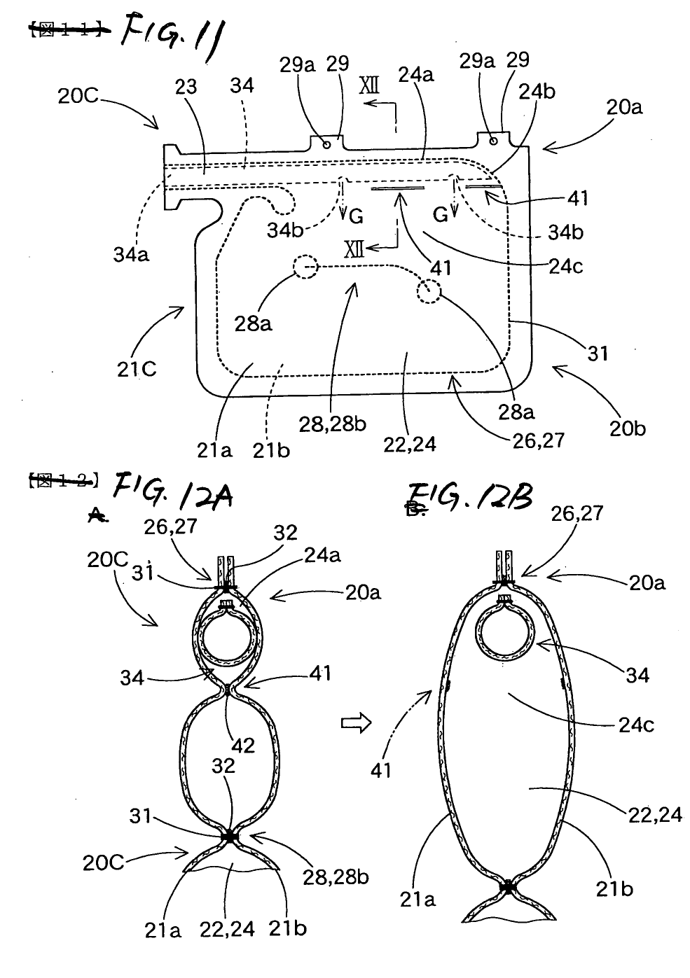

FIG. 11 is a front view of an airbag according to a third embodiment.

FIGS. 12A and 12B are partial sectional views which explain sequentially states where the airbag according to the third embodiment inflates, which corresponds to a location indicated by the line XII-XII in FIG. 11.

### DETAILED DESCRIPTION OF THE PREFERRED EMBODIMENTS

To describe embodiments of the invention hereinbelow based on the drawings, a head protecting airbag 20 according to a first embodiment of the invention is, as shown in FIG. 1, such as to be used in a head protecting airbag apparatus M that is installed on a vehicle V having three rows of seats. This head protecting airbag apparatus M includes, in addition to the airbag 20, another head protecting airbag 18, inflators 12, 13, attachment brackets 10, 14 and an airbag cover 9.

Note that being different from the joined bag type airbag 20 according to this embodiment, the head protecting airbag 18 is formed as an integral type airbag that is formed by hollow or tubular weaving and is folded up to be housed in a range extending from a lower edge of a front pillar portion FP along a lower edge of a roof side rail portion RR to pass by a first intermediate pillar portion P1 to reach a portion of the roof side rail portion RR which is located in the vicinity of a front side of an upper portion of a second intermediate pillar portion P2. Then, when an inflation gas is supplied from the inflator 12 thereinto, the airbag 18 is inflated and deployed to cover interior sides of side windows W1, W2 which are located at the side of first- and second-row seats and the first intermediate pillar portion P1.

In addition, the airbag 20 according to the embodiment is folded up to be housed in an upper edge of a side window W3 which is located at the side of a third-row seat so as to be inflated and deployed so as to cover interior sides of the window W3 and part of a rear pillar portion when an inflation gas is supplied from the inflator 13 thereinto.

As shown in FIG. 1, the inflators 12, 13 are formed as substantially tubular cylinder type inflators, and connection port parts 18a, 23 are fitted on the inflators 12, 13 as portions of the airbags 18, 20 through which the inflation gas is allowed to flow into the airbags 18, 20, respectively and are connected to the airbags 18, 20 by utilizing clamps 16. Then, the inflators 12, 13 are fixedly attached to an inner panel 2 of the roof side rail portion RR at positions near above the respective intermediate pillar portions P1, P2 by utilizing the attachment brackets 14 while being covered by a lower edge 5a of a roof lining 5. Note that the inner panel 2 is a member on a side of a body 1 of the vehicle V. In addition, the attachment brackets 14 are made from sheet metal to hold the inflators 12, 13 and are fixed to the inner panel 2 by utilizing attaching bolts 15.

The mounting brackets 10 are each made of two strengthening plates which are made of sheet metal and are attached to respective attaching portions 18b, 29 so as to hold the attaching portions 18b, 29 of the air bags 18, 20 by the two strengthening plates so as to fixedly attach the respective attaching portions 18b, 29 to the inner panel 2 with attaching bolts 11. Note that the respective attaching bolts 11 penetrate through the corresponding attaching portions 18b, 29 so as to be fastened into nuts provided in attaching holes in the inner panel 2.

The airbag cover 9 is provided with lower edge 4a, Sa sides of a pillar garnish 4 disposed on the front pillar portion FP and the roof lining 5 disposed on the roof side rail portion RR. Note that the front pillar garnish 4 and the roof lining 5 are made of synthetic resin and are fixedly attached to an interior side of the inner panel 2 of the body 1 at the front pillar portion FP and the roof side rail portion RR, respectively. In addition, the roof lining 5 is provided to extend from near above the front pillar portion FP to pass by above the intermediate pillar portions P1, P2 to reach near above the rear pillar portion RR.

The head protecting airbag 20 according to the first embodiment includes, as shown in FIGS. 1 to 4, a bag body 21, an inner tube 34 and a support cloth 38 which supports the inner tube 34.

The bag body 21 is configured to include a gas-flowing portion 22 into which the flow of an inflation gas G from the inflator 13 is allowed and a non-gas-flowing portion 26 into which the flow of the inflation gas G is prohibited. The gas-flowing portion 22 is configured to include an inflation main part 24 which inflates so as to cover the side window W3 and a cylindrical connection port part 23 which projects forward in substantially a horizontal direction from an upper side (an upper edge) of the inflation main part 24 to thereby be connected to the inflator 13 which supplies the inflation gas G. The non-gas-flowing portion 26 is configured to include a peripheral edge portion 27 which defines a peripheral edge of the gas-flowing portion 22, a thickness restricting portion 28 that is disposed at a vertically intermediate location of the inflation main part 24 so as to cause the inflation main part 24 to inflate into a plate-like shape and attaching portions 29 that are provided on an upper edge 20a side of the airbag 20.

Then, this bag body 21 is of a joined bag type and is formed into a bag-like shape by joining together outer peripheral parts of an interior wall portion 21a and an exterior wall portion 21b which are made of a flexible cloth material that is formed by plain woven polyester yarns, polyamide yarns and the like through stitching using a stitching thread 31 and bonding using an adhesive 32. Then, the peripheral edge portion 27 and the thickness restricting portion 28 of the non-gas-flowing portion 26 are formed by joining the wall portions 21a, 21b to each other by making use of stitching and bonding.

Note that annular joined portions 28a are provided at front and rear ends of the thickness restricting portion 28, and the thickness restricting portion 28 is formed into a shape in which the front and rear joined portions 28a, 28a are connected by a curved joined portion 28b. In addition, the attaching portions 29 are formed at a plurality of locations (two locations in the embodiment) on the upper edge 20a side of the airbag 20, and each of the attaching portions 29 is formed in such a state the wall portions 21a, 21b are superposed double and has formed therein an attaching hole 29a through which an attaching bolt 11 is passed.

The inner tube 34 is formed as a substantially cylindrical shape in which a connecting tubular portion 34a, which is disposed on an inner peripheral surface side of the connection port part 23 so as to be fitted on the inflator 13, is disposed at a front end side thereof and has gas outlet ports 34b which are provided in a lower surface thereof at a plurality of locations (two locations in the embodiment) which are arranged in series in a longitudinal direction of the inner tube 34 so as to allow the inflation gas G from the inflator 13 to flow downward from an upper edge 24a side of the inflation main part 24. This inner tube 34 is formed, as shown in FIG. 6, by folding a tube base cloth 35 made of a flexible cloth material that is formed by plain woven polyester yarns, polyamide yarns and the like into two halves and stitching together outer peripheral parts of the halved portions with a stitching thread 36. Then, this inner tube 34 is formed to have an outside diameter which is substantially equal to an inside diameter of the connection port part 23 of the bag body 21 and a length which allows the inner tube 34 to extend rearward from the connection port part 23 along the upper edge 24a side in the inside of the inflation main part 24 to come into abutment with a rear edge 24b of the inflation main part 24 at a rear end thereof in such a state that the connecting tubular portion 34a is disposed within the connection port part 23.

Note that this inner tube 34 is disposed in such a state that a portion thereof that is in the vicinity of the connecting tubular portion 34a is stitched to the connection port part 23 in order to prevent the deflection of the inner tube 34 relative to the connection port part 23 when the inflator 13 is inserted while the other locations than that of the inner tube 34 are not joined directly to the inflation main part 24.

The longitudinal length of the support cloth 38 is made shorter than that of the inner tube 34 (in this embodiment, the longitudinal length of the former is made on the order of one seventh of the length of the latter which extends along a longitudinal direction of the upper edge 24a of the inflation main part 24). This support cloth 38 is made of a flexible cloth material that is formed by plain woven polyester yarns, polyamide yarns and the like and is joined to the inflation main part 24 so as to support the inner tube 34 while wrapping up a location of the inner tube 34 between the gas outlet portions 34b, 34b which is clear of both the gas outlet portions 34b, 34b. In the case of the first embodiment, the support cloth 38 is formed such that a vertically extending belt-like base cloth 39 is folded into two halves from a fold provided in the vicinity of a vertical center thereof and interposing superposed upper end portions 39a, 39a of the base cloth 39 so folded between the wall portions 21a, 21b when the peripheral edge portion 27 is formed on the upper edge 24a side of the inflation main part 24 so that the superposed upper end portions 39a, 39a are joined integrally to the bag body 21 when the wall portions 21a, 21b are joined to each other through bonding and stitching.

To describe the manufacturing of the head protecting airbag 20 according to the first embodiment, as is shown in FIG. 5A, the adhesive 32 is applied to positions on an inner surface of, for example, the exterior wall portion 21b of the wall portions 21A, 21B of the bag body 21 where the peripheral edge portion 27 and the joined portions 28a, 28b of the thickness restricting portion 28 are disposed. Then, the base cloth 39 is folded into two halves, and the upper end portions 39a, 39a are disposed at the position along the peripheral edge portion 27 at which the support cloth 38 is disposed. Then, as shown in FIG. 5B, the interior wall portion 21a is superposed on the exterior wall portion 21b, and the adhesive 32 applied location is pressurized such that a uniform bonding force is generated along the entire periphery of the peripheral edge portion 27. Note that the adhesive 32 is also applied between the upper end portions 39a, 39a and to external surfaces thereof as appropriately. Thereafter, as shown in FIG. 5C, the wall portions 21a, 21b are stitched to each other along the adhesive 32 applied locations together with the upper end portions 39a, 39a by making use of the stitching thread 31 to thereby produce the bag body 21.

Then, the inner tube 34, which has been produced in advance, is inserted into the connection port part 23 of the bag body 21 so that a leading end thereof that initiated the insertion comes to be disposed in the vicinity of a rear end 24b of the inflation main part 24 while allowing the inner tube 34 to pass through the inside of the support cloth 38 that is formed into the substantially tubular shape and is then stitched to the connection port part 23 at the portion thereof that is in the vicinity of an open end of the connecting tubular portion 34a, whereby the airbag 20 can be produced.

To describe the installation of the airbag 20 so produced on to the vehicle V, first of all, the airbag 20 is folded up in a bellows-like fashion such that a lower edge 20b side is caused to approach an upper edge 20a side, and a breakable tape, not shown, is wrapped around the airbag 20 so folded up so as to prevent the collapse of such a folded state of the airbag 20.

Furthermore, the inflator 13 to which the attachment bracket 14 has already been attached is inserted into the connecting tubular portion 34a that is located on an inner peripheral side of the bag body 21 and is then connected to the connection port part 23 of the airbag 20 by making use of the clamp 16, and the attachment brackets 10 are attached to the respective attaching portions 29 of the airbag 20.

Thereafter, the respective brackets 10, 14 are disposed at predetermined positions on the body 1 side inner panel 2 and are then fixedly fastened to the inner panel 2 with the bolts 11, 15 which are passed through the respective attaching holes 29a, whereby the airbag 20 can be fixed to the body 1 side inner panel 2.

Note that as in the case with the airbag 20, the airbag 18 is folded up, is then connected to the inflator 12 and the brackets 10, and is finally fixedly fastened to the inner panel 2 with the bolts 11, 15.

Then, lead wires which extend from a predetermined inflator activating control unit are connected to the inflators 12, 13, and the front pillar garnish 4 and the roof lining 5 are attached to the body 1. Furthermore, a rear pillar garnish 6 and intermediate pillar garnishes 7, 8 are attached to the body 1. Thus, the airbag apparatus M can be installed in the vehicle V.

In the event that the inflators 12, 13 are activated after the airbag apparatus M has been installed in the vehicle V, the inflation gas G from the inflators 12, 13 flows into the airbags 18, 20, so that the airbags 18, 20 break the tapes, not shown, which have been wrapped therearound and, furthermore, push open the airbag cover at the lower edges 4a, 5a sides of the front pillar garnish 4 and the roof lining 5 to project downward, whereby the airbags 18, 20 are allowed to inflate and deploy largely so as to cover the interior sides I of the side windows W1, W2, W3 and the pillar portions P1, P2 as shown in chain double-dashed lines in FIG. 1.

Then, in the head protecting airbag 20 according to the first embodiment of the invention, since the support cloth 38 is formed as the substantially tubular shape which wraps up the inner tube 34 and is joined to the upper edge 24a side of the inflation main part 24 above the inner tube 34, both the interior wall portion 21a and the exterior wall portion 21b of the inflation main part 24 are, as shown in FIG. 3, not joined to the inner tube 34 and the support cloth 38 but are allowed to be separated from each other over the whole area of the inflation main part 24 that is located near directly below the inner tube 34, so that a protecting area 24c with a predetermined thickness can be provided at the time of inflation. Since the outer periphery of the inner tube 34 is wrapped up by the substantially tubular support cloth 38 except for the locations thereof that are in the vicinity of the gas outlet ports 34b, the deflection of the inner tube 34 is, of course, prevented at the initial of inflation of the airbag 20, whereby the inflation gas G is allowed to flow from the gas outlet ports 34b, 34b to a lower side of the inflation main part 24 in an accurate fashion, so that the inflation and deployment behaviors of the airbag 20 can be stabilized.

Consequently, in the head protecting airbag 20 of the first embodiment of the invention, the deflection of the inner tube at the initial stage of inflation of the airbag 20 can be suppressed and the protecting area 24 that is inflated to the predetermined thickness can be provided over the whole area of the inflation main body 24 which is located directly below the inner tube 34.

In addition, in the head protecting airbag 20 of the first embodiment of the invention, the inner tube 34 is provided within the bag body 21 so as to be separated with respect to the inner peripheral surface of the inflation main part 24 of the bag body 21 except for the location in the vicinity of the connection port part 23, and the short support cloth 38 is integrally joined to the upper edge 20a side of the bag body 21 instead of joining the long inner tube 34 directly to the upper edge 20a side of the joined bag type bag body 21 except for the location in the vicinity of the connection port part 23, so that the inner tube 34 is constructed to be supported by making use of the support cloth 38.

Namely, in the event that the long inner tube 34 is interposed between the interior and exterior side wall portions 21a, 21b so as to be directly joined to the upper edge 20a side of the joined bag type bag body 21 when the interior and exterior wall portions 21a, 21b are joined to each other at the upper edge 20a side of the bag body 21, the variation in joining allowance of the interior and exterior wall portions 21a, 21b that are joined together makes it difficult to secure a predetermined inside diametrical dimension of the inner tube 34 over the full length thereof. In the airbag of the first embodiment of the invention, however, since the inner tube 34 itself is only interposed between the outer peripheral parts of the interior and exterior wall portions 21a, 21b of the bag body 21 and is not joined integrally, the predetermined inside diametrical dimension of the inner tube 34 can be secured over the full length thereof.

In addition, in the event that the long inner tube 34 is interposed between the interior and exterior side wall portions 21a, 21b so as to be joined to the upper edge 20a side of the joined bag type bag body 21, when joining together the outer peripheral parts of the interior and exterior wall portions 21a, 21b of the bag body 21 using an adhesive, the location where the long inner tube 34 is not interposed is affected by the greater thickness of the location where the inner tube 34 is interposed in such a way that the pressing force cannot smoothly be applied thereto at the time of adhesion to thereby generate a variation in bonding force, leading to a risk that there is caused a problem in manufacturing the bag body 21. In the airbag 20 of the first embodiment of the invention, however, since only the short support cloth 38 is interposed between the interior and exterior wall portions 21a, 21b, the aforesaid undesirable effect can be suppressed as much as possible.

Note that while, in the airbag 20 of the first embodiment of the invention, the support cloth 38 is described as being formed into the substantially tubular shape by folding the single belt-like base cloth 39 into the two halves, a slit or cut may be provided in a portion of the cloth 39 where a fold is to be provided in advance so that the folding at the fold so produced can be implemented smoothly. Furthermore, as in a head protecting airbag 20A shown in FIGS. 7, 8, a substantially tubular support cloth 38A may be formed by making use of two belt-like base cloths 39A, 39A in place of the single belt-like base cloth 39.

Namely, in this airbag 20A, first of all, as shown in FIG. 7A, one of the base cloths 39A is disposed at a predetermined position on an inner surface of an exterior wall portion 21b of a bag body 21A, and an adhesive 32 is applied to positions on the inner surface of the exterior wall portion 21b where a peripheral edge portion 27 and joined portions 28a, 28b of a thickness restricting portion 28 are disposed and to an upper end portion 39a and a lower end portion 39b of the base cloth 39A. Thereafter, the other base cloth 39A is superposed on the base cloth 39A, and as shown in FIG. 7B, the interior wall portion 21a is superposed on the exterior wall portion 21b, and the adhesive 32 applied locations including the lower end portions 39b, 39b of the base cloths 39A, 39A are pressurized such that a uniform bonding force is generated over the entire periphery of the peripheral edge portion 27. Note that the adhesive 32 may be applied to sides of the upper end portions 39a which face the respective wall portions 21a, 21b as appropriately. Thereafter, as shown in FIG. 7C, the wall portions 21a, 21b are stitched to each other along the adhesive 32 applied location together with the upper end portions 39a, 39a by utilizing a stitching thread 31, whereby a bag body 21A is produced.

Then, the inner tube 34 that has been produced in advance is inserted into a connection port part 23 of the bag body 21A so that a leading end thereof that initiated the insertion comes to be disposed in the vicinity of a rear end 24b of an inflation main part 24 while allowing the inner tube 34 to pass through the inside of the support cloth 38A that is formed into the substantially tubular shape and is then stitched to the connection port part 23 at the portion thereof that is in the vicinity of an open end of a connecting tubular portion 34a, whereby the airbag 20A can be produced. This airbag 20A can provide similar function and advantage to those of the airbag 20.

In addition, as shown in a head protecting airbag 20B of a second embodiment of the invention shown in FIGS. 9, 10, the inner tube 34 may be supported using a support cloth 38B that is provided with a single base cloth 39B.

This airbag 20B is such that in the process of producing the airbag 20A shown in FIG. 7A, an adhesive 32 is applied to a lower end portion 39b of the base cloth 39B so that the lower end portion 39b is bonded to the side of an exterior wall portion 21b, whereby a bag body 21B is produced.

Then, the inner tube 34 that has been produced in advance is inserted into a connection port part 23 of the bag body 21B so that a leading end thereof that initiated the insertion comes to be disposed in the vicinity of a rear end 24b of an inflation main part 24 while allowing the inner tube 34 to pass through between the exterior wall portion 21b and the support cloth 38B and is then stitched to the connection port part 23 at the portion thereof that is in the vicinity of an open end of a connecting tubular portion 34a, whereby the airbag 20B can be produced.

As in the first embodiment of the invention, the airbag 20B of the second embodiment of the invention is also such as to be installed in a vehicle for use. Then, in this airbag 20B, the support cloth 38B is provided integrally with the inflation main part 24 on an upper end 39a side thereof, when portions of the outer peripheral parts of the interior and exterior wall portions 21a, 21b which are located on the upper edge 24a side of the inflation main part 24 above the inner tube 34 are joined to each other, while being joined on a lower end 39b side thereof to a portion of the exterior wall portion 21b of the inflation main part 24 which is located near directly below the inner tube 34, so as to have a shorter longitudinal length than that of the inner tube 34 and to wrap up the same tube 34.

Due to this, also in this head protecting airbag 20B, since the support cloth 38B is connected to the upper edge 24a side of the inflation main part 24 above the inner tube 34 and the portion of the exterior wall portion 21b side of the inflation main part 24 that is located near directly below the inner tube 34 while wrapping up the inner tube 34 at the location clear of the gas outlet ports 34b, 34b, the interior wall portion 21a and the exterior wall portion 21b are not joined to each other over the whole area of the inflation main part 24 that is located near directly below the inner tube 34 so as to be separated from each other, thereby making it possible to provide a protecting area 24c with a predetermined thickness at the time of inflation. In this case, too, since the inner tube 34 is wrapped up by the support cloth 38B and the exterior wall portion 21b to which the lower end 39b side of the support cloth 38B is connected, the deflection of the inner tube 34 at the initial stage of inflation of the airbag 20B can, of course, be prevented.

Consequently, also in the head protecting airbag 20B of the second embodiment of the invention, the deflection of the inner tube 34 at the initial stage of inflation of the airbag 20B can be suppressed, and the protecting area 24c that is inflated to the predetermined thickness can be provided over the whole area of the inflation main part 24 that is located directly below the inner tube.

In addition, also in this airbag 20B, since the inner tube 34 itself is not interposed between the outer peripheral parts of the interior and exterior wall portions 21a, 21b of a bag body 21B for integral joining, the predetermined inside diametrical dimension of the inner tube 34 can be secured over the full length of the inner tube 34. Furthermore, since the support cloth 38B is made shorter than the inner tube 34, when joining together the outer peripheral parts of the interior and exterior wall portions 21a, 21b of the bag body 21B by making use of the adhesive 32, the pressing force required at the time of bonding can be applied smoothly to the whole area of the bonding location 27 compared with a case where the inner tube 34 is integrally joined to the bag body 21B along the full length of the inner tube 34.

Note that in the case of the airbag 20B of the second embodiment of the invention, the lower end portion 39b may be joined to the side of the interior wall portion 21a, and as this occurs, the inner tube 34 is to be inserted between the interior wall portion 21a and the support cloth 38B. In addition, when joining the lower end portion 39b to either the exterior wall portion 21b or the interior wall portion 21a, stitching may be used as appropriately in addition to bonding in order to eliminate a risk of gas leakage.

Next, to describe a head protecting airbag 20C of a third embodiment of the invention shown in FIGS. 11, 12, in this airbag 20C, the inner tube 34 is supported using not the support cloth 38 but interior and exterior wall portions 21a, 21b of a bag body 21C.

Namely, in this airbag 20C, locations 41 where the interior wall portion 21a and the exterior wall portion 21b of an inflation main part 24 are joined to each other near below portions of the inner tube 34 which are spaced away from the gas outlet ports 34b are provided at two positions. In this embodiment, these joined locations 41, 41 are joined together using an adhesive 42 such that the wall portions 21a, 21b can be separated from each other when the internal pressure of the airbag 21C is increased as the time is approaching when the inflation main part 24 completes its inflation.

Due to this, in this airbag 21C, the separably joined locations 41 and an upper side of the inflation main part 24 that is located above the joined locations 41 support the inner tube 34 until the time near the completion of inflation of the inflation main part 24 when the joined locations 41 are separated.

In production of this airbag 20C, the adhesive 32 and the adhesive 42 are applied to positions on an inner surface of, for example, the exterior wall portion 21b of the wall portions 21a, 21b of the bag body 21C where a peripheral edge portion 27 and joined portions 28a, 28b of a thickness restricting portion 28 are disposed and, furthermore, to positions where the joined locations 41 are disposed. Thereafter, the interior wall portion 21a is superposed on the exterior wall portion 21b, and the adhesive 32, 42 applied portions including the joined portions 28a, 28b and the joined locations 41, 41 are pressurized such that a uniform bonding force is generated over the entire periphery of the peripheral edge portion 27. Thereafter, the wall portions 21a, 21b are stitched to each other with a stitching thread 31 along the peripheral edge portion 27 and the joined portions 28a, 28b of the adhesive 32 applied locations, whereby the bag body 21C is produced. Note that the adhesive 32 may be applied to the positions of the joined locations 41 in place of the adhesive 42 by adjusting the amount of the adhesive that is applied and the pressing force.

Then, the inner tube 34 that has been produced in advance is inserted into a connection port part 23 of the bag body 21C so that a leading end thereof that initiated the insertion comes to be disposed in the vicinity of a rear end 24b of the inflation main part 24 while allowing the inner tube 34 to pass through above the joined locations 41 and is then stitched to the connection port part 23 at the portion thereof that is in the vicinity of an open end of a connecting tubular portion 34a, whereby the airbag 20C can be produced.

As in the first embodiment of the invention, the airbag 20C of the third embodiment is also such as to be installed in a vehicle for use. Then, in this airbag 20C, since the joined locations 41, 41 where the interior and exterior wall portions 21a, 21b of the inflation main part 24 are allowed to be separated from each other and the upper side of the inflation main part 24 that is located above the joined locations 41 support the inner tube 34 at the initial stage of inflation where the inflation gas from the inflator is allowed to flow into the inflation main part 24, the deflection of the inner tube 34 is suppressed, whereby the inflation gas G is allowed to flow from the gas outlet ports 34b toward a predetermined direction within the inflation main part 24. Then, when the internal pressure value is increased as the time is approaching when the inflation main body 24 completes its inflation, the joined locations 41, 41 near below the inner tube 34 where the interior and exterior wall portions 21a, 21b are joined to each other are separated as indicated in FIGS. 12A, 12B, thereby making it possible to provide a protecting area 24c with a predetermined thickness over the whole area located near below the inner tube 34.

Consequently, also in the head protecting airbag 20C of the third embodiment, the deflection of the inner tube 34 at the initial stage of inflation of the airbag 20C can be suppressed, and the protecting area 24c that is inflated to the predetermined thickness can be provided over the whole area of the inflation main body 24 that is located below the inner tube 34.

In addition, being different from the airbags 20, 20B of the first and second embodiments, in the airbag 20C of the third embodiment, since the support cloths 38, 38B are not interposed between the outer peripheral parts of the interior and exterior wall portions 21a, 21b of the bag body 21C, when applying the adhesive 32 to both the outer peripheral parts of the interior and exterior wall portions 21a, 21b of the bag body 21C and pressurizing the adhesive applied portion, a uniform pressurizing force can easily be applied to the entire periphery of the outer peripheral parts, thereby making it possible to stabilize the sealing performance of the airbag 20C to be produced. Also in this airbag 20C, since the inner tube 34 itself is not interposed between the outer peripheral parts of the interior and exterior wall portions 21a, 21b of the bag body 21C for integral joining, the predetermined inside diametrical dimension of the inner tube 34 can be secured over the full length thereof.

Note that in the airbags 20, 20A, 20B, 20C of the respective embodiments, while the inner tube 34 is described as being inserted into the airbag main bodies 21, 21A, 21B, 21C after the airbag main bodies 21, 21A, 21B, 21C have been produced, the inner tube 34 may be so disposed before the interior wall portion 21a and the exterior wall portion 21b are superposed on each other, and thereafter, the airbags 20, 20A, 20B, 20C may be produced.

In addition, in the respective embodiments, while bonding and stitching are described as being used together with each other when producing the airbag main bodies 21, 21A, 21B, 21C by the outer peripheral parts of the interior and exterior wall portions 21a, 21b including the thickness restricting portion 28 and the upper end portion 39a of the base cloths 39, 39A, 39B, the airbag main bodies 21, 21A, 21B, 21C may be produced by making use of at least one of bonding and stitching, provided that sufficient joining strength and sealing characteristic can be secured.

What is claimed is:

1. A head protecting airbag folded and housed in an upper part of a window so as to be inflatable to cover an interior side of the window when an inflation gas flows therein, including:
a bag body provided with a joined bag formed by joining outer peripheral parts of an interior wall portion and an exterior wall portion, the bag body having an inflation main part which is inflatable to cover the window when the inflation gas is allowed to flow therein and a tubular connection port part which communicates with an upper side of the inflation main part so as to be connected to an inflator for supplying the inflating gas; and
an inner tube which extends in the connection port part along an upper edge of an inside of the inflation main part and which has a gas outlet port for supplying the inflation gas downward;
wherein the inner tube is housed within the bag body so as not to be joined to an inner peripheral surface of the inflation main part of the bag body except for a location that is in a vicinity of the connection port part, and
an outer periphery of the inner tube except for a location that is in a vicinity of the gas outlet port is supported by a support cloth which is joined integrally to the inflation main part to have a tubular shape such that the support cloth wraps around the inner tube within the inside of the inflation main part,
wherein the support cloth has a shorter longitudinal length than that of the inner tube, and
a part of the support cloth is joined to the outer peripheral parts of the interior and exterior wall portions, when upper edges of the outer peripheral parts of the interior and exterior wall portions located above the inner tube are jointed to each other.

2. A head protecting airbag folded and housed in an upper part of a window so as to be inflatable to cover an interior side of the window when an inflation gas flows therein, comprising:
a bag body provided with a joined bag formed by joining outer peripheral parts of an interior wall portion and an exterior wall portion, the bag body having an inflation main part which is inflatable to cover the window when the inflation gas is allowed to flow therein and a tubular connection port part which communicates with an upper side of the inflation main part so as to be connected to an inflator for supplying the inflating gas; and
an inner tube which extends in the connection port part along an upper edge of an inside of the inflation main part and which has a gas outlet port for supplying the inflation gas downward;
wherein the inner tube is housed within the bag body so as not to be joined to an inner peripheral surface of the inflation main part of the bag body except for a location that is in a vicinity of the connection port part, and
an outer periphery of the inner tube except for a location that is in a vicinity of the gas outlet port is supported by a support cloth which is joined integrally to the inflation main part to have a shape such that the support cloth wraps around the inner tube within the inside of the inflation main part,
wherein the support cloth has a shorter longitudinal length than that of the inner tube, and
an upper edge of the support cloth is joined to upper edges of the outer peripheral parts of the interior and exterior wall portions located above the inner tube, when the outer peripheral parts of the interior and exterior wall portions are jointed to each other and
a lower edge of the support cloth is joined to one of the interior and exterior wall portions at a location below the inner tube.

3. A head protecting airbag folded and housed in an upper part of a window so as to be inflatable to cover an interior side of the window when an inflation gas flows therein, comprising:
a bag body provided with a joined bag formed by joining outer peripheral parts of an interior wall portion and an exterior wall portion, the bag body having an inflation main part which is inflatable to cover the window when the inflation gas is allowed to flow therein and a tubular connection port part which communicates with an upper side of the inflation main part so as to be connected to an inflator for supplying the inflating gas; and
an inner tube which extends in the connection port part along an upper edge of an inside of the inflation main part and which has a gas outlet port for supplying the inflation gas downward;
wherein the inner tube is housed within the bag body so as not to be joined to an inner peripheral surface of the inflation main part of the bag body except for a location that is in a vicinity of the connection port part, and
wherein a separable portion between the interior and exterior wall portions which is formed by separably joining the interior and wall portions to each other are located below the inner tube except for a location that is in a vicinity of the gas outlet port, such that the separable portion of the inflation main part and an upper part of the inflation main part located above the separable portion support the inner tube,
the separable portion is separated at a time when an internal pressure of the inflation main part is increased before a completion of inflation of the inflation main part.
